(19) United States
(12) Patent Application Publication
(10) Pub. No.: US 2015/0188985 A1
(43) Pub. Date: Jul. 2, 2015

(54) DEVICE AND METHOD FOR UNIDIRECTIONAL DATA TRANSFER

(71) Applicant: AIRBUS DEFENCE AND SPACE SAS, LES MUREAUX (FR)

(72) Inventors: Jean-Luc Marty, Montbrun Lauragais (FR); Jean-Luc Laffitte De Petit, Baziege (FR)

(21) Appl. No.: 14/404,613

(22) PCT Filed: Aug. 19, 2013
(86) PCT No.: PCT/EP2013/067259

§ 371 Date: Nov. 29, 2014

(30) Foreign Application Priority Data
Aug. 16, 2012 (FR) 1202242

(51) Int. Cl. H04L 29/08; H04L 29/06

(52) U.S. Cl. CPC H04L 67/06; H04L 69/16

(57) ABSTRACT

A method for unidirectional data transfer between a first open network and a second protected network. Data is transferred from a sender desk connected to the open network to a receiver desk connected to the protected network via at least one transmission path comprising a physical data diode. A file is transmitted from the sender desk to the receiver desk, packet by packet, upon arrival of the packets at the sender desk. The numbering of packets is used to reconstruct the file at the receiver desk. Data is transmitted on N (N>=2) parallel transmission paths, each protected by a physical diode. Data is received by the receiver desk in N buffer memories.

The present invention pertains to the field of information transmission systems.

It relates more particularly to a system allowing the unidirectional transmission of data between two servers, hereinafter referred to as “desks”, in one direction only, commonly referred to by the person skilled in the art as a “data diode”.

More precisely, the invention is aimed at novel systems making it possible to carry out unidirectional transmission of data satisfying demanding application constraints in terms of both security and bitrate, as well as the mechanisms for implementing such transmission.

### PREAMBLE AND PRIOR ART

The problem of the unidirectional transmission of data is related in a first example of applications to information transmission from a non-secure domain (for example the Internet) to a secure domain (for example a military control center), this transmission having to be carried out without it being possible to transmit information from the secure domain to the non-secure domain through the transmission pathway used.

A second example of use of unidirectional data transmission systems is the inverse case of transmission of data from the secure world to the non-secure world. Such is the case for example when transmitting non-confidential data formulated in the secure domain (a factory for example) and transmitted to the non-secure domain (Internet) through a unidirectional transmission pathway. This unidirectional linkup from the secure world to the non-secure world makes it possible to prevent operators of the non-secure world being able to intervene in a malicious manner in the secure world by using this transmission pathway.

According to the prior art, a unidirectional data transmission system uses a physical component referred to as an “optical data diode”. This is a transmission pathway whose medium of support is an optical fiber, this component being adapted so that the signal can physically travel in one direction only, thereby presenting the dual advantage of rendering it impossible to transmit information in the other direction through this linkup, and of not emitting electromagnetic radiation that could be spied on, unlike an electrical component.

Such electromagnetic radiation might allow reconstitution of the transmitted data.

The use of these devices for transmitting data, termed “data diodes” between areas with different security levels makes it possible:
to transmit information from the less secure world to the more secure world,
to prohibit any communication from the more secure world to the less secure, and thus to avoid any information leakage.

Another mode of use is conceivable: the transmission of information from a protected world to an outside world while avoiding any intrusion into the former.

The unidirectional data transmission systems 20 on the market are based on almost identical architectures. They consist of three main elements (see FIGS. 1 and 2):
a sender desk 10, this desk commonly being a computerized server,
a receiver desk 12, this desk also being a computerized server,
an optical diode 11 ensuring a unidirectional transmission pathway between the sender desk 10 and the receiver desk 12,
means of supervision 23 of the assembly.

In the two above-described examples of applications, either the sender desk 10 forms part of the non-secure world and the receiver desk 12 forms part of the secure world, or conversely the sender desk 10 forms part of the secure world and the receiver desk 12 forms part of the non-secure world. In the ensuing description we shall deal with the first case of application.

In this case, the sender desk 10 commonly receives files from the non-secure world 13 through an FTP (File Transfer Protocol) server 21 as regards file transfer based on TCP-IP (Transmission Control Protocol-Internet Protocol) stacks.

However, unidirectional transmission is in fact performed using other data transfer protocols known to the person skilled in the art as UDP (User Datagram Protocol) used to undertake stream transfer. This acknowledgment-less protocol relies on the layers of more Ethernet level (akin to level 1 and 2 of the OSI model) and IP level (level 3 of the OSI model) which are monodirectional protocols. The advantage with respect to TCP is of not requiring any acknowledgment of receipt, it not being possible for such an acknowledgment to be returned by the receiver desk to the sender desk through the unidirectional data linkup.

When a file is received by the sender desk 10, it is transmitted to the receiver desk 12 through the optical diode 11, generally after it has been received in its entirety. This optical diode 11 is passive and ensures that no information can travel from the receiver desk 12 of the secure world to the sender desk 10 of the non-secure world. Once the file has been received by the receiver desk 12, it is stored and made available to users by using a network 14 of the secure world linked to the receiver desk 12 via, for example, an FTP server 22.

FIG. 3 gives an overview of the exchanges in respect of a transmission between a source 30 of data and a target 31 of these data, through such a system for unidirectional data transmission 20, according to the prior art.

In the absence of communication from the receiver desk to the sender, it is impossible to deploy stream control and on-arrival control mechanisms at the level of the receiver desk, which are conventionally used to ensure reliable end-to-end communications between a data sender and receiver. (Stream control makes it possible to slow down the sender desk and to not saturate the memories during reception. On-arrival control makes it possible to ensure that no frame is lost and to re-request transmission if appropriate.)

It is therefore necessary to send the data with high redundancy. Therefore the mechanism used to enhance the reliability of transmission according to the prior art of data-diode-based transmission systems is the multiple dispatching of each file through said data diode. It is commonplace to re-send the data four or five times by way of security. Hence, the data bitrate is thereby reduced accordingly. The effect of this is to divide the bandwidth in proportion to the number of retransmissions. Such a system 20 exhibits a low data bitrate (typically 10 to 40 Mbit/s) with respect to “conventional” data transmission devices, which is insufficient for certain applications, for example for transmitting satellite images.

Moreover, data losses may occur at the level of the receiver desk, for example in case of saturation of the receiver desk, without it being possible to perform any correction of the data file.

The aim of the invention is therefore to remedy these problems of low data bitrate and impossibility of correction of data files after reception.

### DISCLOSURE OF THE INVENTION

For this purpose, the present invention is aimed firstly at a method of unidirectional transfer of data between a first network termed the open network, and a second network termed the secure network, said method being used to transfer data from a sender desk linked to the open network (a desk being defined as a computerized system containing hardware and software which are used to store, process and transmit digital information), to a receiver desk linked to the secure network, through at least one transmission pathway comprising a physical data diode.

The method comprises a step of transmitting a file in the course of reception from the sender desk to the receiver desk, packet by packet as soon as said packets arrive at the level of the sender desk, and of using the numbering of the packets to reconstruct the file on the receiver desk side.

According to a particular implementation, the method comprises a step of sending the data to be transmitted, on N (N>=2) transmission pathways in parallel, each protected by a physical diode, and a step of reception by the receiver desk of the data received, in N buffer memories (buffers).

In this case, more particularly, the method comprises a step of introducing a temporal stagger between the redundant information transmitted on the various transmission pathways.

According to a particular implementation, the method comprises a step of assigning the operations of reading the packets received on the receiver desk a higher priority level than the other operations performed on this receiver desk.

According to a first implementation, the method comprises the following steps:

300—a file source deposits a file on the sender desk,

610—as soon as a block of the file, configured in a file transfer protocol of TCP (Transmission Control Protocol) type is received by the sender desk and acknowledged, it is transmitted to an application layer managing a file transfer protocol of FTP (File Transfer Protocol) type for processing and reconstitution of the file, as well as to an application (an application being defined as a computerized program, hard-wired or programmed logic performing operations on digital data) in charge of encapsulating it in a protocol without acknowledgment of receipt, such as UDP (User Datagram Protocol),

620—the UDP frames containing the file block are dispatched to the receiver desk through each diode,

630—on receipt of the UDP frames, the receiver desk extracts the TCP information from the frame and an application uses the numbering information contained in the TCP frame to verify that all the blocks necessary for the reconstruction of the file are present.

According to a second implementation, the method comprises the following steps:

300—a file source deposits a file on the sender desk,

710—as soon as a TCP block of the file is received by the sender desk and acknowledged, it is dispatched directly on an MAC-LLC level (Media Access Control protocol—Logical Link Control logical link control sub-layer) to be transmitted as is through each diode,

720—on receipt of the TCP blocks the receiver desk uses the numbering information contained in the TCP frame to verify that all the blocks necessary for the reconstruction of the file are present.

According to a third implementation, the method comprises the following steps:

300—a file source deposits a file on the sender desk,

810—as soon as a TCP block of the file is received by the sender desk and acknowledged, the file block extracted from the TCP layer is retrieved, and then duplicated,
dispatched to an FTP server, and
dispatched to a transmission agent in charge of transferring it to the receiver desk through each diode,

820—parallel transmission of the file block,

830—at the level of the receiver desk, extraction, by a software application AppliH, from the buffer memories (buffers), corresponding to the transmissions performed through each diode, the blocks which have arrived and processes the first of them that it recognizes as correct, the other instances being eliminated.

In this third implementation, in step 810, the transfer is for example carried out using the MAC-LLC level.

Alternatively, in step 810, the transfer is carried out using the IP/UDP (Internet Protocol/User Datagram Protocol) level.

According to a particular implementation, in step 810, the TCP layer, at the level of the sender desk, carries out two functions:
management of the FTP protocol so as to dispatch an acknowledgment of receipt to the sender,
association, by a function AppliB, of an index number with the file block as well as a file reference, and transmission so as to forward the file block to the receiver desk through each optical diode.

According to a particular implementation, step 830 also comprises the reconstruction of the file and its storage or the sending of an alert of the supervision function in case of packet loss.

According to a particular implementation, in step 810, an appliB to appliH exchange protocol ensuring the following functions is implemented:

811•managing the sequencing of the exchanges,

812•tagging the block transmitted in a unique manner, doing so for a given file (for the case of recovery),

813•checking that there are no missing file blocks for its reconstruction,

814•finalizing file transfer on recovery solely of the missing blocks,

815•taking into account the events of the FTP protocol so as to echo them on the transfers between the two desks.

In this case, more particularly, in step 815, an interruption of the FTP transfer is manifested by an indication to the receiver desk to stop listening and to erase the file part already received.

The invention is aimed under a second aspect at a device suitable for implementing a method such as set forth.

According to a particular embodiment, the device comprises means for sending the data to be transmitted, on N (N>=2) transmission pathways in parallel, each protected by a physical diode, and in that the receiver desk comprises means of receiving the data transmitted in N buffer memories (buffers).

In this case, according to a more particular embodiment, the device comprises means of introducing a temporal stagger between the redundant information transmitted on the various transmission pathways.

The invention is aimed at a system (comprising a device and a method such as have been set forth) for unidirectional transmission of data between a desk of a non-secure network, and a desk of a secure network, said system being used to transmit data from one of the desks termed the “sender desk” to the other of the desks termed the “receiver desk”. The system comprises at least two unidirectional data transmission pathways linking the sender desk and the receiver desk and means adapted for transmitting the data by numbered packets from the sender desk to the receiver desk, each of the packets being transmitted by the at least two unidirectional transmission pathways as so many copies.

In diverse modes of implementation, optionally used in conjunction when this is technically possible:
the system introduces a temporal stagger into the transmission of each copy of a data packet by at least two unidirectional transmission pathways.
the system transfers each numbered packet to the receiver desk as soon as this packet is received by the sender desk without waiting for the complete reception of the data by the sender desk.
the system reconstructs the data at the level of the receiver desk on the basis of the copies of numbered packets transmitted to this desk. More particularly, in this case, the system uses the numbering of the packets to reconstitute the data.
the reconstitution of the data at the level of the receiver desk is performed just once.
with each of the at least two unidirectional transmission pathways is associated a buffer memory in which the copies of the packets transmitted by said pathway are stored. More particularly, in this case, said buffer memories associated with said at least two unidirectional transmission pathways are of the “first in-first out” type. Still in this case, favorably, the system permanently extracts the copies of the packets present in said buffer memories. Yet more particularly, the system verifies that at least one copy of the packets of like index number that were extracted from the buffer memories is correct. According to a favorable mode of implementation, in this case, the system processes the first copy of each packet extracted from a buffer memory and recognized as correct for purposes of data reconstitution, the other copies not being processed.
the operations of reading the packets stored in the buffer memories have a higher priority level than the other operations performed by said system at the level of the receiver desk.
the data packets are configured at the level of the sender desk with the characteristics of the data transfer frames of a data transmission protocol of TCP (Transmission Control Protocol) type, and then these TCP packets are encapsulated according to a data transmission protocol with no acknowledgment of receipt before being transmitted to the receiver desk through the unidirectional transmission pathways.
the data to be transmitted are stored in the sender desk for an appreciably longer duration than the duration of transmission and of reconstitution of said data in the receiver desk, and when a data packet is incorrect or missing for said reconstitution of said data, the system dispatches this information to a data retrieval system which transmits to the sender desk the order to return said incorrect or missing packet stored at the level of this desk.

### PRESENTATION OF THE FIGURES

The characteristics and advantages of the invention will be better appreciated by virtue of the description which follows, which description sets forth the characteristics of the invention through a nonlimiting exemplary application.

The description is given in the case of a unidirectional transmission of data from a non-secure world to a secure world. The inverse case is deduced directly therefrom. The description is supported by the appended figures which represent:

FIG. 1 (already cited): an illustration of the general disposition of a system for unidirectional data transmission from a non-secure world to a secure world,

FIG. 2 (already cited): a diagram of the main constituents of a unidirectional data transmission system of the prior art,

FIG. 3 (also already cited): an overview of the end-to-end exchanges performed by such a system for unidirectional data transmission of the prior art,

FIGS. 4a and 4b: diagrams of connectors of passive and reactive type,

FIG. 5: a diagram of a unidirectional data transmission system according to the invention suitable for sending information under redundancy over three parallel unidirectional transmission pathways, with a temporal stagger,

FIG. 6: a schematic illustration of a first variant of a connector implementing a method according to the invention,

FIG. 7: a schematic illustration of a second variant of a connector implementing a method according to the invention,

FIG. 8: a schematic illustration of a third variant of a connector implementing a method according to the invention,

FIG. 9: functional diagrams of the secure and non-secure servers in a variant of implementation of the invention,

FIG. 10: a logic diagram of the steps of an exemplary implementation of the method according to the invention,

FIG. 11: a logic diagram of the steps of a second exemplary implementation of the method according to the invention,

FIG. 12: a logic diagram of the steps of a third exemplary implementation of the method according to the invention,

FIG. 13: a logic diagram detailing functions carried out in a step of the method illustrated in FIG. 12.

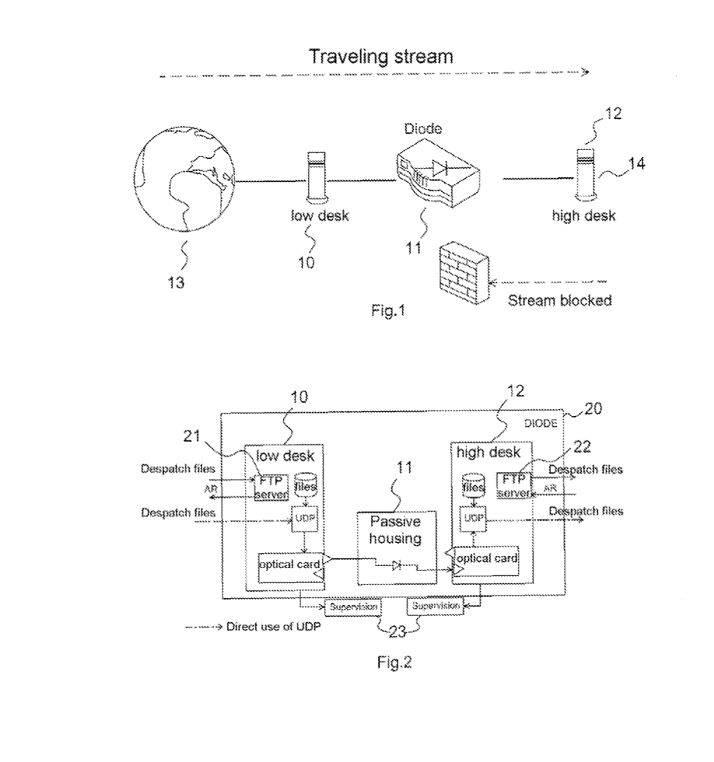

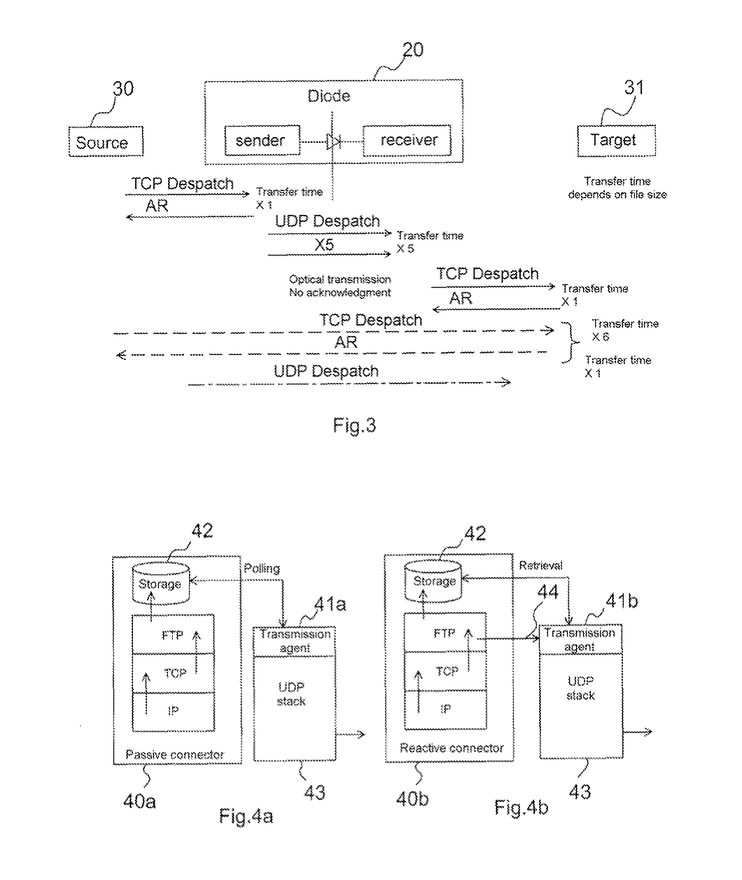

### DETAILED DESCRIPTION OF AN EMBODIMENT OF THE INVENTION

The invention is aimed at both a device and a method, together forming a data transmission system of data diode type.

The data transmission system described here relies on three elements:

1/ a method allowing the parallel transmission of data that are made redundant so as to increase the data bitrate while guaranteeing the quality of the transmission.

2/ a connector designed to reduce to the maximum the latency times related to the handling of the file so as to perform its transfer.

3/ selective retransmission by an operator in case of data loss.

1/ Management of the Redundancy of Information Transmission

Use of Several Unidirectional Physical Links.

To reduce the risks of data losses, unidirectional data transmission systems (data diodes) according to the prior art manage information redundancy by series transmission of redundant data. The system described here introduces a redundancy in parallel into the transmission of the data, so that it is not necessary to reduce the bandwidth.

The device uses for this purpose three optical links (three being taken by way of example) to allow simultaneous transfer on the three links. It is clear that this number could be two or any value greater than three.

The data are transmitted packet-wise on the three optical links and stored in three buffer memories on the receiver desk 12. Each packet is transmitted through each of the unidirectional links, therefore three times. The system verifies at the level of the receiver desk 12 that at least one copy of each packet is correct and that all the packets have been transmitted. The way of accessing these three links can differ according to the technology employed.

Accordingly, the information must be sent simultaneously on several physical links protected by physical diodes. With this type of system, in theory the bitrate limitation is now constrained only by the bandwidth of the unidirectional link. To this should be added the limitations introduced by the implementation of the data link access protocols and the encapsulation of the information that is useful to define the effective actual bitrate thereof.

This shows that particular care must be taken regarding the choice of the physical and logical elements used to link the two desks. If off-the-shelf elements are the choice, it is necessary to limit the choice to protocols having neither acknowledgment of receipt nor stream control.

In an exemplary implementation, with a 1 Gbit/s UDP/Ethernet conventional protocol stack, it is possible to attain bitrates of 800 Mbit/s over a linkup and if the information is transmitted directly without using UDP by dispatching the information directly by 1 Gbit/s Ethernet with 1500-byte frames, it is possible to attain bitrates of more than 980 Mbit/s.

Temporal Stagger of the Dispatching of the Redundant Information

The losses being related to the saturation of the reception buffer memories (buffers), one chooses to use algorithms which make it possible to temporally stagger the dispatches to the receiver desk 12 of the frames containing the redundant information. This makes it possible to ensure that in the case of saturation of a buffer memory at a given instant, the loss of the packets can be offset by the retrieval of the information a little later on another linkup. Therefore a desynchronization is introduced between the information transmitted over the various physical linkups by the introduction of a delay mechanism on sending between the various physical linkups.

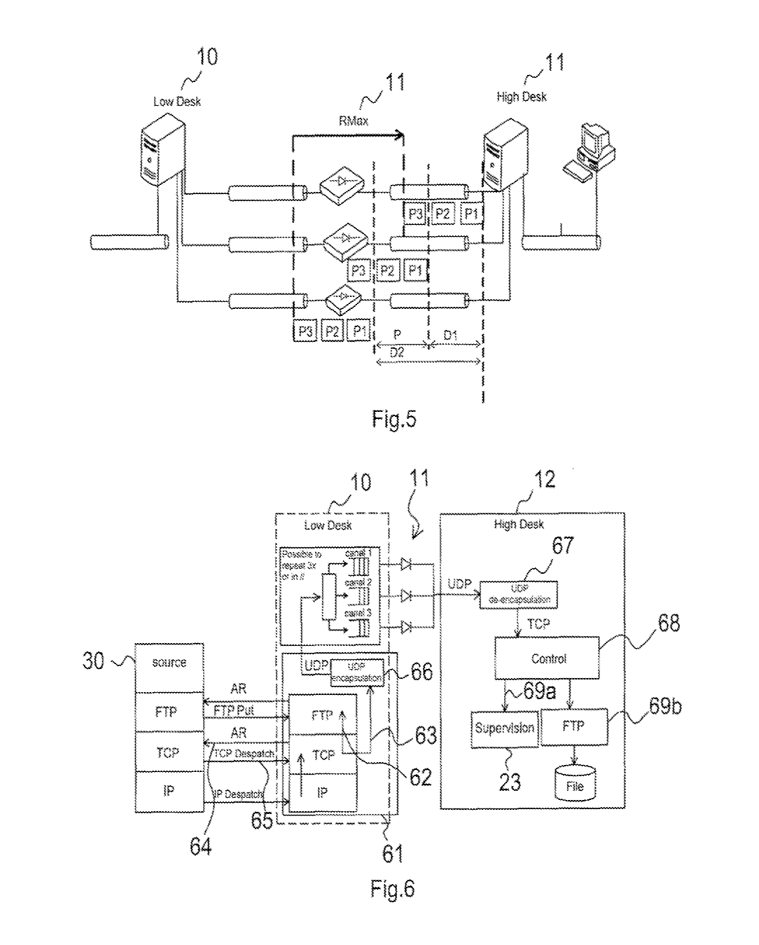

FIG. 5 represents the transmission on three physical linkups. The transmission of packets P1, P2 and P3 is staggered by D1 between linkup 1 and linkup 2 and by D2>D1 between linkup 1 and linkup 3. In case of saturation of the buffer memories for a time P as represented in FIG. 5 (this typical case is merely illustrative), the packet P3 dispatched on linkup 1 will be lost as will the packets P1 and P2 dispatched on linkup 2. The information will then be reconstituted on the basis of the packets P1 and P2 received by linkup 1 and of the packet P3 of linkup 2. If the saturation were to be more significant, it will further be possible to use linkup 3 to reconstitute the whole set of packets.

It should be noted that in the worst case, the information can only be reconstituted after reception of the last packet on the last linkup. This then introduces a delay equal to RMax (see FIG. 5) during the reception of the message. Therefore if it is desired to have the specified bitrate, this lag must be taken into account. Its influence on the bitrate is inversely proportional to the size of the file.

After having described this mechanism which makes it possible to increase the bitrate while preserving the security of the transfer by redundancy, it is important to note that it is necessary to preserve a flexibility of configuration in regard to the mechanism parameters which will be able to be adapted as a function of the hardware considered. These parameters are:
the number of linkups for transporting the redundancy
the lags introduced for the desynchronization.

Indeed, the deploying of additional mechanisms on the receiver desk so as to avoid the saturation of the buffer memories during reception may require the optimization of these parameters.

The redundancies in respect of information sending are introduced to offset the losses, which stem notably from the saturation of the reception buffer memories. Hence the mechanisms for reading the buffer memories on the receiver desk 12 are assigned a higher priority level than the other processings (for example verification of file integrity, running of anti-virus, etc.).

Moreover, for the receiver desk 12, hardware is chosen which makes it possible to limit the saturation of the reception buffer memories, and therefore to reduce the losses.

Parametrizable mechanisms are provided for on the receiver desk 12 and the sender desk 10, according to the type of hardware supporting the servers and the context of use.

The number of redundancy elements and the temporal stagger between the retransmissions of one and the same packet are inversely proportional to the capacity of the hardware.

2/ Connector

A constituent mechanism (implemented in the form of hard-wired or programmed logic) of the unidirectional data transmission system is described here. This mechanism described in FIGS. 4a and 4b is referred to as a connector. Its role is to determine when data are present in the sender desk 10 and are awaiting transfer to the receiver desk 12.

There exist two main types of connectors: passive connector or reactive connector.

A passive connector 40a consists for example of an FTP (File Transfer Protocol) server. A transmission agent 41a (implemented in the form of a software application) is in charge of polling a tree of folders (in a storage area 42) at fixed frequency and of determining whether a file to be transmitted has been received. If such is the case, the transmission agent 41a retrieves the file and instructs its transmission to the receiver desk 12, through a UDP stack 43.

It is possible to preserve, during transmission, an item of information regarding the location of the file transmitted in the starting tree (at the level of the sender desk 10) and to store the file transmitted in an identical tree, on the receiver desk 12 side. This makes it possible to have on the receiver desk 12 side a “mirror” of the server on the sender desk 10 side.

A reactive connector 40b consists of an element capable, on the one hand, of managing an FTP protocol so as to receive the file and, on the other hand, of alerting the agent of transmission 41b to the receiver desk 12, of the presence of an element to be dispatched. On receipt of this alert, the transmission agent 41b retrieves the file in the storage area 42 and prepares it for the transfer, through the stack UPD 43.

The implementation of a reactive connector 40b requires the use of a modified FTP layer (capable of signaling directly to the transmission agent the arrival of a file, action symbolized by the arrow 44 in FIG. 4b) whereas in the first case it is possible to use any off-the-shelf component.

In both cases (passive connector or reactive connector), existing data diodes introduce latency on the sender desk 10.

The transmission of a file is commenced only when the latter has been entirely deposited on the sender desk 10. This introduces a latency time dependent on the size of the file.

The mechanisms for detecting presence of a file to be transmitted are more or less efficacious depending on whether dealing with a reactive connector 40b or a passive connector 40a, and depending on the implementation choices (for example: polling frequency, communication between FTP server and transmission agent, etc.).

The aim of the connector described here, with respect to the connectors of the prior art, is to dispense with the latency time introduced by the reception of the file on the sender desk. Indeed the existing mechanisms necessitate the presence of the entire file on the sender desk 10. To improve this point it is necessary to have the capacity to transfer the file on the fly during its reception. This makes it possible to save the latency time related to waiting for the complete file.

The idea is to forward the file from the sender desk 10 to the receiver desk 12 packet by packet as soon as they arrive and to make use of the numbering of the packets to reconstruct the file on the receiver desk 12 side.

Three variants are described here, non-limitingly, for deploying such a connector:

Variant 1: UDP Encapsulation

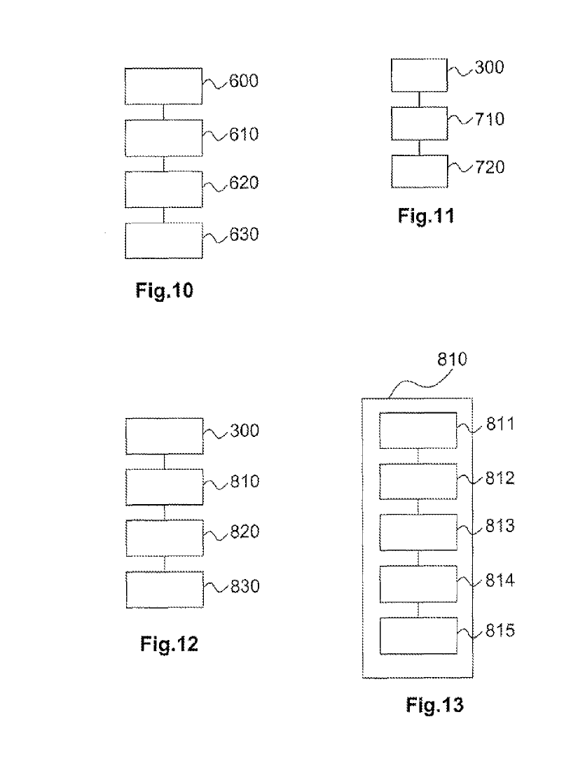

In a first variant, termed UDP encapsulation (see FIGS. 6 and 10), a file source 30 deposits a file on the sender desk 10. But in contradistinction to the prior art, the connector 61, according to this exemplary implementation of the invention, does not wait for the arrival of the entire file in order to begin transmitting from the sender desk 10 to the receiver desk 12. As soon as a TCP (Transmission Control Protocol) packet, or block, of said file is received by the sender desk 10 (arrow 65 in FIG. 6) and acknowledged (arrow 64 in FIG. 6), it is transmitted (arrow 62 in FIG. 6) to the FTP layer for processing and reconstitution of the file, as well as (arrow 63 in FIG. 6) to an application 66 in charge of encapsulating it in a UDP protocol. The UDP frames are dispatched to the receiver desk 12 through the optical diodes 11.

On receipt of the UDP frames, an application of the receiver desk 12 extracts the TCP information of the UDP frame (UDP de-encapsulation function 67, that is to say operation inverse to an encapsulation, which is an addition of data at the start and/or at the end of the dispatched file) and a control application 68 uses the numbering information contained in the TCP frame to verify that all the blocks necessary for the reconstruction of the file are present.

In case of detected loss of a block (function 69a FIG. 6), an alert is dispatched to an operator, for example human, to request manual recovery of the transmission of the missing elements of the file.

If there is no loss of data (function 69b FIG. 6), the reconstructed file is stored at the level of the receiver desk 12.

This UDP encapsulation variant affords another advantage in the embodying of the unidirectional data transmission system 20. Indeed, in order to avoid creating a new on-arrival control element, the TCP (Transmission Control Protocol) packet numberings are used for this purpose, by diverting them from their original use.

The receiver desk 12 does not perform the functions of a TCP layer as regards stream regulation and acknowledgments, it preserves only the on-arrival control function 68.

One difficulty is to correctly follow the exchanges between the FTP client of the file source, and the FTP server of the sender desk 10 since these exchanges take place on two ports, the first devoted to control, and the second devoted to the data. It is then preferable to choose to work in passive mode on very particular ports. In this mode FTP server itself determines the connection port to be used to allow data transfer (data connection) and communicates it to the client. This makes it possible to oversee the ports used by the sender desk.

One of the limitations of this UDP encapsulation variant is the obligation to retrieve the information in the three (in the case where three diodes are used in parallel) buffer memories associated with the three optical diodes 11 and to de-encapsulate (function 67) the TCP packet in each UDP packet so as to be able to undertake the on-arrival control (function 68).

Variant 2: TCP (Transmission Control Protocol) Direct Transfer

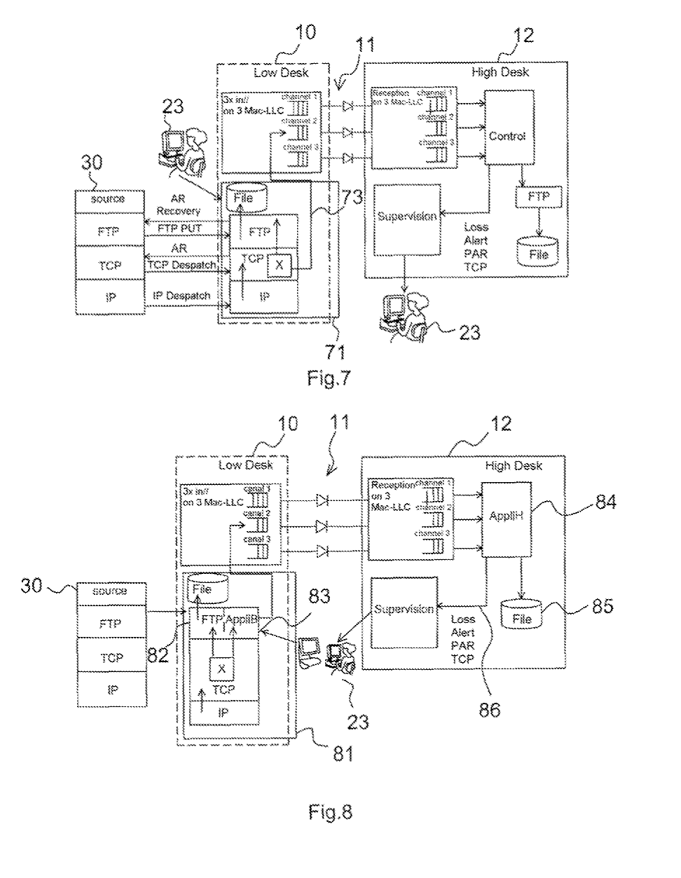

In a second variant termed TCP direct transfer (illustrated in FIGS. 7 and 11), to gain in terms of performance, a UDP encapsulation is no longer undertaken. The connector 71 dispatches the TCP packet directly (arrow 73 in FIG. 7) on an MAC-LLC (Media Access Control-Logical Link Control) level so as to be transmitted as is.

It is recalled that according to the definition in use, Media Access Control (MAC) is a sub-layer, according to the IEEE 802.x computerized networks standards, of the lower part of the data link layer in the OSI model. It serves as interface between the software part controlling the link of a node (Control of the logical link) and the physical layer (hardware). The Logical Link Control (LLC) sub-layer is the top half of layer 2—link—of the OSI model, which makes it possible to enhance the reliability of the MAC protocol by error control and stream control.

On the receiver desk 12 side, no UDP de-encapsulation needs to be carried out, thereby making it possible to increase the buffer memories' extraction performance and therefore to decrease cases of loss by overwriting in the input buffer memories.

The on-arrival controls (block 68) are done, as in the first variant, with the control elements contained in the TCP protocol. Dispensing with the encapsulation 66 and with the de-encapsulation step 67 increases the useful bitrate between the two desks.

Variant 3: Transfer of File Blocks

In a third variant termed file block transfer (see FIGS. 8 and 12), the difference, in relation to the TCP direct transfer variant, pertains to the fact that instead of transferring the TCP packet, the connector 81 retrieves the file block extracted from the TCP layer, and then transfers it to an FTP function 82 and to an application (denoted

AppliB in the subsequent description) 83 in charge of transferring it on the other side of the diodes 11 and using the MAC-LLC level directly.

This TCP layer, at the sender desk 10 level, carries out two functions:
management of the FTP protocol so as to respond (dispatch an acknowledgment of receipt) to the sender desk, the effect of which at the level of the source 30 is to reconstruct the file as would a conventional FTP server and to store it
execution of an application AppliB 83 the objective of which is to associate an index number with the file block corresponding to the file elements extracted from the TCP protocol, as well as a file reference and to transmit it to the MAC-LLC layers so as to forward it to the receiver desk 12 through the optical diodes 11.

Information redundancy is ensured by parallel transmission of the file block. Each block transmitted by a data diode is stored in a buffer memory associated with the diode. The buffer memories of the three diodes are of the “first in-first out” (FIFO) type. This remark is valid for each of the three variants described.

At the level of the receiver desk 12, a software application AppliH 84 extracts from the buffer memories (buffers), corresponding to the transmissions performed in parallel, the blocks which have arrived and processes the first of them that it recognizes as correct based on the block index numbers and its knowledge of the expected index number, the other instances not being processed. Its objective is to reconstruct the whole of the logical string of numbered blocks.

This makes it possible to avoid irrelevant processings which could lead to losses by saturations of the buffer memories. The application appliH 84 is in charge of the reconstruction of the file and its storage 85 or of alerting (function 86) the supervision function 23 in case of loss of blocks.

The applications AppliB and AppliH are designed in such a way that the AppliB to AppliH exchange protocol ensures the following functions (FIG. 13):
managing the sequencing of the exchanges,
tagging the block transmitted in a unique manner, doing so for a given file (for the case of recovery),
checking that there are no missing file blocks for its reconstruction,
finalizing the file transfer on recovery solely of the missing blocks,
taking into account the events of the FTP protocol so as to echo them on the transfers between the two desks. For example, an interruption of the FTP transfer is manifested by an indication to the receiver desk 12 to stop listening and to erase the file part already received.

With regard to the cases of failure recovery, if a block is missing and the file cannot be reconstructed, an alert message is dispatched to the supervision 23, indicating the characteristics of the packets to be retransmitted (packet index number, file).

With respect to the other two variants (FIGS. 6 and 7), recovery is made easier since there is no need to preserve any information in respect of the association between the block index numbers and the file blocks, the software application AppliB then being capable of making the direct linkup as the index number and the file to be considered.

In this variant of file block transfer, management of the reception of files in parallel is made easier. The same holds for retransmission in case of loss.

In a variant, if it is desired to make developments of the applications AppliB and

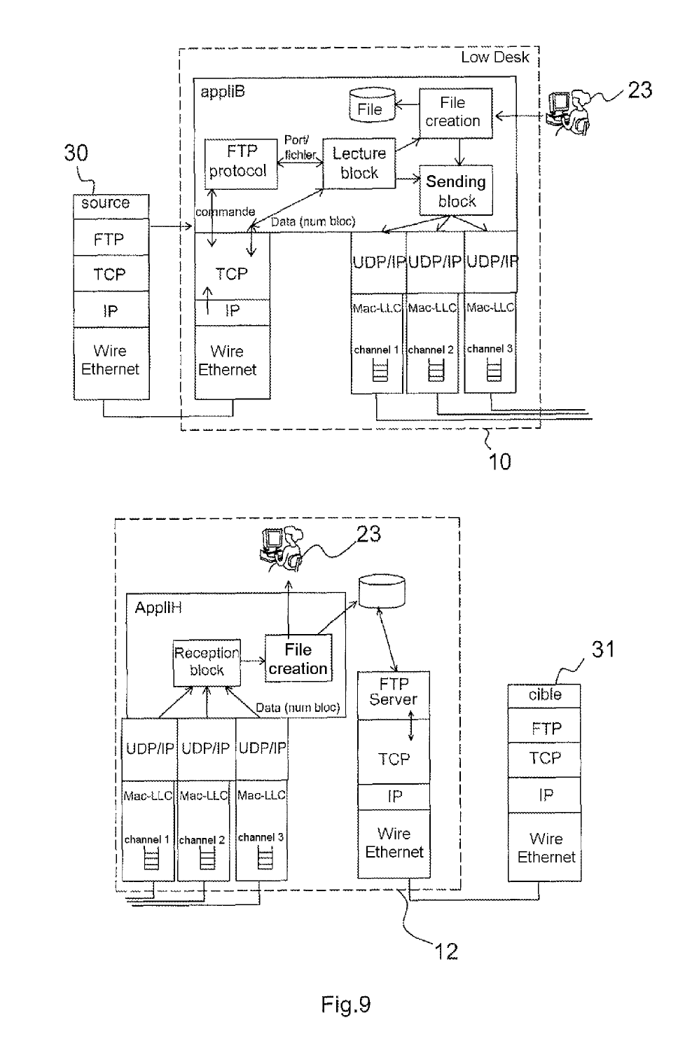

AppliH somewhat easier, while conceding a small loss of performance, it is possible to use an IP/UDP standard protocol stack instead of attacking the MAC/LLC layers directly. This gives the diagrams of FIG. 9.

The gains introduced by the connectors 61, 71, 81 which have just been described, in three variants of implementation, depend on the framework of use. The most favorable cases with respect to the prior art are as follows:
the transfer of big files. Indeed the waiting time for the entire file (for current functional operation) is proportional to the size of the file;
the case where the end-to-end bitrate of the unidirectional data transmission system (complete: desks+physical elements) is higher than the bitrate of the supply linkup of the sender desk. In the converse case the diode plays the role of funnel and therefore introduces a latency. This is all the more true as the input stream is sustained.

The connector, such as described, makes it possible to reduce the file reception time which may be significant in the case of a big file.

3/ Introduction of a Contextual Manual Recovery Function.

In principle, in a data diode, it is not possible to return acknowledgments from the receiver desk 12 to the sender desk 10, and to request retransmissions of data. But there may still be cases where irretrievable data losses do not make it possible to reconstruct the file.

In the absence of command of the sender desk 10 by the receiver desk 12, it is known to use an operator to perform error recoveries. If elements are detected as missing, an alert is uploaded to an operator 23 in charge of manually relaunching the transfer of the file concerned.

The method described here makes it possible to deploy selective retransmission. Indeed, the sender desk 10 is in charge of preserving the classification and the numbering of the packets which have been dispatched to the receiver desk 12. When it is impossible for the latter to reconstruct a file because it has lost some blocks, it provides the operator 23 with the identification of the lost blocks. The operator 23 then provides this information to the sender desk 10 which retransmits only the necessary blocks. This type of recovery may make it possible to raise retransmission performance in the case of big files:
By avoiding taking a significant additional lag in the case of complete retransmission.
By avoiding potentially reproducing the same failure caused by the repetition of the same scenario.

### Advantages

The device and the methods described above make it possible to improve the performance of unidirectional data transmission systems in terms of bitrate and latency time.

The connector makes it possible to undertake information transfer on the fly without waiting for the complete arrival of a file.

The introduction of a parallel information redundancy makes it possible to avoid dividing the bandwidth of the physical medium by the number of transmissions of the information to avoid losses.

Manual selective recovery allows an operator to relaunch only a retransmission of the blocks lost and not of the entire file.

1-13. (canceled)

14. A method of unidirectional transfer of data between an open network and a protected network, comprising the steps of:
transmitting a file from a sender desk linked to the open network to a receiver desk linked to the protected network through at least one transmission pathway comprising a physical data diode, the file is transmitted packet by packet as soon as packets arrive at a sender desk level, and the file is reconstructed at the receiver desk using a numbering of the packets;
sending the data to be transmitted on N (N>=2) transmission pathways in parallel, each protected by a physical data diode; and
receiving of data in N buffer memories by the receiver desk.

15. The method as claimed in claim 14, further comprising the step of introducing a temporal stagger between redundant information transmitted on the transmission pathways.

16. The method as claimed in claim 14, further comprising the step of assigning a higher priority level to an operation of reading the packets received by the receiver desk than other operations performed by the receiver desk.

17. The method as claimed in claim 14, further comprising the steps of:
receiving the file from a file source by the sender desk;
transmitting a block of the file configured in a file transfer protocol of a Transmission Control Protocol (TCP) type upon receipt and acknowledgment by the sender desk to an application layer managing a file transfer protocol of a File Transfer Protocol (FTP) type for processing and reconstitution;
transmitting the block file to an application in charge of encapsulating the block of file in an User Datagram Protocol (UDP) or a protocol without acknowledgment of receipt;
dispatching UDP frames containing the file block to the receiver desk through each physical data diode;
extracting the TCP information from the UDP frames by the receiver desk; and
verifying all blocks necessary for reconstruction of the file are present using the numbering information contained in the TCP frame by the receiver desk.

18. The method as claimed in claim 14, further comprising the steps of:
receiving the file from a file source by the sender desk;
dispatching a Transmission Control Protocol (TCP) block of the file upon receipt and acknowledgment by the sender desk directly on a Media Access Control protocol-Logical Link Control logical link control sub-layer (MAC-LLC) level to be transmitted as is through each physical data diode; and
verifying all blocks necessary for reconstruction of the file are present using the numbering information contained in a TCP frame on receipt of TCP blocks by the receiver desk.

19. The method as claimed in claim 14, further comprising the steps of:
receiving the file from a file source by the sender desk;
retrieving a file block extracted from a Transmission Control Protocol (TCP) layer upon receipt and acknowledgment of a TCP block of the file by the sender desk;
dispatching by the sender desk, the file block to a File Transfer Protocol (FTP) server and to a transmission agent in charge of parallel transmission of the file block on transmission pathways to the receiver desk through each physical data diode;
extracting the file blocks that have arrived from the buffer memories corresponding to the parallel transmission through each physical data diode by the receiver desk; and
processing the file block recognized as being correct and eliminating file block not recognized as being correct.

20. The method as claimed in claim 19, further comprising the step of dispatching the file block by the sender desk using a Media Access Control protocol-Logical Link Control logical link control sub-layer (MAC-LLC) level.

21. The method as claimed in claim 19, further comprising the step of dispatching the file block by the sender desk using an Internet Protocol/User Datagram Protocol (IP/UDP) level.

22. The method as claimed in claim 19, wherein the physical data diode is an optical diode; and further comprising the steps managing the FTP protocol by the TCP layer at the sender desk level to dispatch an acknowledgment of receipt to the file source; associating an index number and a file reference with the file block by the TCP layer at the sender desk level; and transmitting the file block, the associated index number and the associated file reference to the receiver desk through each optical diode.

23. The method as claimed in claim 19, further comprising the step of reconstructing and storing the file by the sender desk or sending an alert to a supervision desk in case of packet loss.

24. The method as claimed in claim 19, further comprising the step of implementing an appliB to appliH exchange protocol at the sender desk level to:
manage sequencing of exchanges;
uniquely tag each block transmitted for a given file in case of recovery;
verify that there are no missing file blocks for reconstructing the file;
finalize file transfer on recovery solely of the missing blocks; and
account for events of the FTP protocol so as to echo them on the transfers between the sender and receiver desks.

25. The method as claimed in claim 24, further comprising the step of interrupting the FTP transfer by an indication to the receiver desk to stop listening and to erase the file part already received.

26. A device for unidirectional transfer of data between an open network and a protected network, comprising:
at least one transmission pathway comprising a physical data diode
a sender desk linked to the open network;
a receiver desk linked to the protected network through said at least one transmission pathway comprising a physical data diode;
the sender desk transmits a file packet by packet to the receiver desk as soon as packets arrive at a sender desk level on N (N>=2) transmission pathways in parallel, each protected by a physical data diode; and
the receiver desk receives data in N buffer memories and reconstructs the file using a numbering of the packets.
